(19) United States
(12) Patent Application Publication
(10) Pub. No.: US 2023/0088564 A1
(43) Pub. Date: Mar. 23, 2023

(54) LOOPED BATTERY TAB WITH OXIDE COATING

(71) Applicant: Apple Inc., Cupertino, CA (US)

(72) Inventors: Jinjun Shi, San Jose, CA (US); Brian K. Shiu, Sunnyvale, CA (US); Katharine R. Chemelewski, San Jose, CA (US)

(21) Appl. No.: 17/841,285

(22) Filed: Jun. 15, 2022

Related U.S. Application Data
(60) Provisional application No. 63/246,568, filed on Sep. 21, 2021.
(60) Provisional application No. 63/248,283, filed on Sep. 24, 2021.

(51) Int. Cl. H01M 50/534; H01M 50/103; H01M 50/533; H01M 50/586; H01M 50/593; H01M 50/474; H01M 50/119; H01M 50/581; H01M 50/176

(52) U.S. Cl. CPC H01M 50/534; H01M 50/103; H01M 50/533; H01M 50/586; H01M 50/593; H01M 50/474; H01M 50/119; H01M 50/581; H01M 50/176

(57) ABSTRACT

The disclosed technology relates to a looped tab for a battery cell. The looped tab may extend from a set of layers. The looped tab may comprise a first portion adjacent to the set of layers, and a second portion adjacent to an inner sidewall of the enclosure. At least a portion of the first portion and at least a portion of the second portion comprise a covered portion. The covered portion comprises a metal surface and an oxide coating covering the metal surface. The oxide coating is configured to prevent contact between a layer in the set of layers or the inner sidewall of the enclosure and the metal surface.

### PRIORITY

The disclosure claims the benefit under 35 U.S.C. § 119(e) of U.S. Provisional Patent Application No. 63/246,568 entitled “Looped Battery Tab with Oxide Coating”, filed on Sep. 21, 2021, and U.S. Provisional Patent Application No. 63/248,283 entitled “Looped Battery Tab with Oxide Coating”, filed on Sep. 24, 2021, both of which are incorporated herein by reference in their entirety.

### TECHNICAL FIELD

The present disclosure relates generally to battery cells, and more particularly, to a battery cell with a looped tab having a partial oxide coating.

### BACKGROUND

Battery cells are used to provide power to a wide variety of portable electronic devices, including laptop computers, tablet computers, mobile phones, personal digital assistants (PDAs), digital music players, watches, and wearable devices. A commonly used type of battery is a lithium battery, which can include a lithium-ion or a lithium-polymer battery.

Lithium batteries often include cells that are made of alternating layers of anode and cathode electrodes, with a separator disposed there-between. The layers may be packaged in an enclosure. Anode electrodes of the cell may be electrically coupled to a wall of the enclosure where the enclosure is itself, made of a conductive material. The cathode electrodes may require an electrical feedthrough to enable an electrical connection, through the enclosure, to the cathode electrodes.

The feedthrough may comprise a connector that is electrically coupled to a tab to form an external battery terminal. The tab may be made of a conductive material. Such tabs, however, may come into contact with one or more of the layers, such as an anode electrode, of the cell or the cell enclosure. Such contact may cause the battery to be shorted.

### SUMMARY

The disclosed embodiments provide for a battery cell that utilizes a looped tab with an oxide coating to prevent contact between a conductive surface of the tab and the layers of the cell or the enclosure. The battery cell includes a set of layers that include a cathode layer, an anode layer, and a separator layer disposed between the cathode layer and the anode layer. The set of layers are enclosed within an enclosure having an opening for receiving a feedthrough. The feedthrough includes a connector that is electrically coupled to the set of layers to form an external battery terminal. A looped tab extends from the cathode layer or the anode layer. The looped tab is connected to the connector of the feedthrough. The looped tab includes a first portion adjacent to the set of layers and a second portion adjacent to an inner sidewall of the enclosure. The first portion includes a covered portion, the covered portion including a metal surface and an oxide coating covering the metal surface. The oxide coating is configured to prevent contact between the set of layers and the metal surface of the covered portion.

In some embodiments, a method for manufacturing a battery cell is disclosed. The method includes inserting a set of layers within an enclosure through an opening. The set of layers include a cathode layer, an anode layer, and a separator layer disposed between the cathode layer and the anode layer. The method also includes disposing a feedthrough within the opening of the enclosure. The feedthrough includes a connector electrically coupled to the set of layers to form an external battery terminal. The method also includes joining a looped tab extending from the set of layers to the connector. The looped tab includes a first portion adjacent to the set of layers. The first portion includes a covered portion, the covered portion including a metal surface and an oxide coating covering the metal surface. The oxide coating is configured to prevent contact between the set of layers and/or the enclosure and the metal surface of the covered portion. The looped tab also includes a second portion adjacent to an inner sidewall of the enclosure.

In some embodiments, a looped battery tab configured to extend from a set of layers of a battery cell is disclosed. The looped battery tab includes a first portion comprising a covered portion, the covered portion including a metal surface and an oxide coating covering the metal surface. The oxide coating is configured to prevent contact between at least one layer of the set of layers and the metal surface of the covered portion. The oxide coating is also configured to prevent contact between the enclosure and the metal surface of the covered portion. The looped battery tab also includes a second portion. The looped tab is configured to be bent around a spacer so that the spacer is positioned between the first portion and the second portion.

### BRIEF DESCRIPTION OF THE DRAWINGS

The embodiments herein may be better understood by referring to the following description in conjunction with the accompanying drawings in which like reference numerals indicate identical or functionally similar elements. Understanding that these drawings depict only exemplary embodiments of the disclosure and are not therefore to be considered to be limiting of its scope, the principles herein are described and explained with additional specificity and detail through the use of the accompanying drawings in which:

FIG. 1A is a first isometric view of a battery can using two dish or clamshell shaped outer surfaces.

FIG. 1B is a second isometric view of the battery can of FIG. 1A.

FIG. 2 is cross-section view of a battery cell with a looped tab.

FIG. 3 is a detailed cross-section view of the battery cell of FIG. 2.

FIG. 4A is a cross-section view of a battery cell with a looped tab having a partial tape coating.

FIG. 4B is another cross-section view of the battery cell of FIG. 4A.

FIG. 5 is a cross-section view of a battery cell with a looped tab having a partial oxide coating.

FIG. 6 is a cross-section view of an assembled battery.

FIG. 7 is a portable electronic device.

FIG. 8 illustrates an example method for manufacturing a battery cell.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Batteries for portable electronic devices often include cells that are made of alternating layers of anode and cathode electrodes, with a separator disposed there-between. The layers may be packaged in an enclosure and may utilize an electrical feedthrough to make an electrical connection to cathode electrodes through the enclosure. The electrical feedthrough may include a connector (e.g. a pin) electrically coupled to the set of layers to form an external battery terminal.

Conventional battery cells may include a metal tab connected (e.g. welded) to the connector of the feedthrough. Such metal tabs, however, may come into contact with at least one layer of the set of layers or a surface of the enclosure, thereby causing the battery cell to be shorted. Accordingly, there is a need for certain embodiments of tabs for use in battery cells that reduce contact between the tab and the set of layers.

The disclosed technology addresses the foregoing limitations of conventional tabs for battery cells by utilizing a looped tab with an oxide coating to prevent contact between the set of layers or the enclosure and a conductive surface of the looped tab, thereby improving safety performance of the battery.

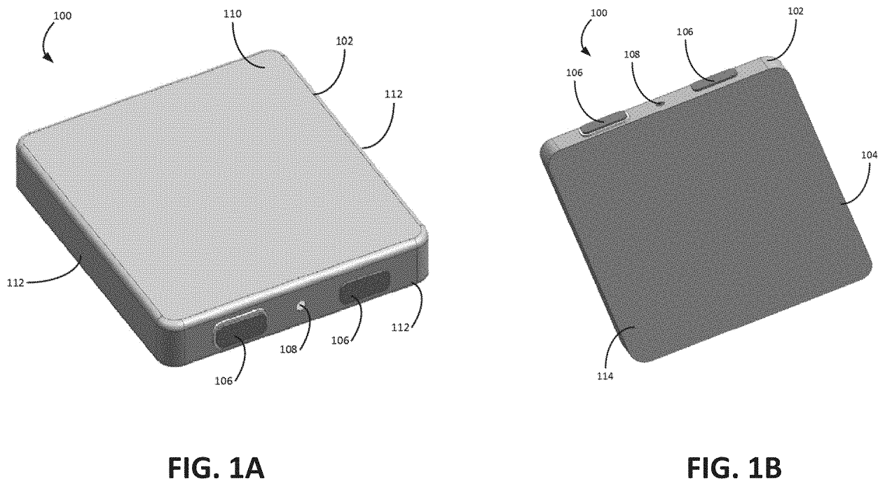

FIGS. 1A and 1B are isometric views of a battery can using two dish or clamshell shaped outer surfaces. In particular, the battery can 100 includes a first portion, or upper portion 102, that has an optionally flat or semi-flat surface 110 and four walls 112 that extend from the flat or semi-flat surface. In general, the dimensions (e.g., width and length) of the flat or semi-flat surface 110 are larger than the dimensions of the walls 112 such that the four walls are smaller in area than the larger flat or semi-flat surface to form a rectangular-shape with an opening along one of the larger surfaces of the rectangle. The regions of the first portion 102 where the surface 110 meets the four walls 112 may form an edge. In some embodiments the edge can have a right angle or may be rounded. Similarly, the regions of the first portion 102 where the four walls 112 meet may form a corner; in some embodiments the corner may be a right angle, an obtuse angle, an acute angle or may be rounded. In addition, one or more feedthroughs 106 may be located on a wall 112 of the first portion 102. The feedthroughs 106 provide electrical connections to a set of layers contained within the battery can 100. In addition, one or more fill holes 108 may also be located on a wall 112 of the first portion 102. The fill hole 108 may or may not be on the same wall 112 of the first portion 102 as the feedthroughs 106.

The battery can 100 may also include a second portion 104. In one embodiment, the second portion 104 includes a similar shape as the first portion 102, namely, a flat or semi-flat surface 114 and four walls that extend from the surface to form a rectangular-shape with an opening along one of the larger surfaces of the rectangle. The length and width of the flat or semi-flat surface 114 may include slightly smaller dimensions than corresponding dimensions of the flat or semi-flat surface 110 of the first portion 102. Thus, when mated, the walls of the second portion 104 fit inside the walls 112 of the first portion 102 to form a box-like enclosure. In another embodiment, the second portion 104 includes the flat or semi-flat surface 114. In general, the dimensions of the flat or semi-flat surface 114 of the second portion 104 may be the same or similar to the flat or semi-flat surface 110 of the first portion 102 such that, when mated, the first and second portion of the battery can form a box-like enclosure for housing a set of layers.

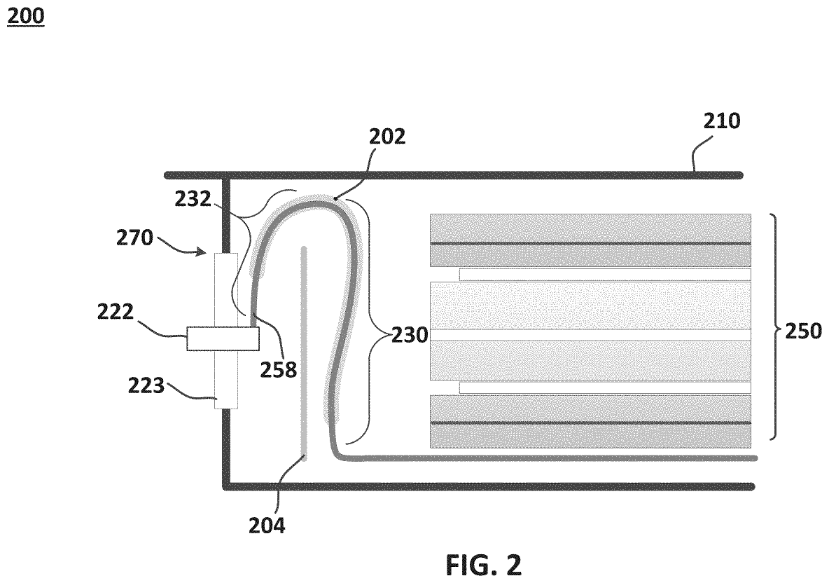

FIG. 2 illustrates a cross-section view of a battery cell 200 with a looped tab 258, in accordance with various aspects of the subject technology. The battery cell 200 comprises an enclosure 210, a set or plurality of layers 250 enclosed within the enclosure 210, and the looped tab 258.

The enclosure 210 may be formed of a rigid material, such as a metal alloy which may, for example, include stainless steel, aluminum, aluminum alloy, or other sufficiently rigid materials as would be known by a person of ordinary skill in the art. The enclosure 210 may have a non-corrosive coating line the interior of the enclosure 210 and is configured to enclose and protect one or more sets of electrodes or layers disposed within the enclosure. The enclosure 210 may have a cylindrical, cuboid, prism, conical, pyramid, combinations thereof or still other shape. The enclosure 210 may have one or more openings 270. The one or more openings 270 may each be configured to receive a feedthrough 223. The enclosure 210 may comprise, for example, the battery can 100 discussed above with reference to FIG. 1.

The feedthrough 223 may comprise a connector 222 (e.g., a pin) electrically coupled to the set of layers to form an external battery terminal. The connector 222 may comprise a metal or alloy, or other material that is capable of conducting electricity, such as molybdenum.

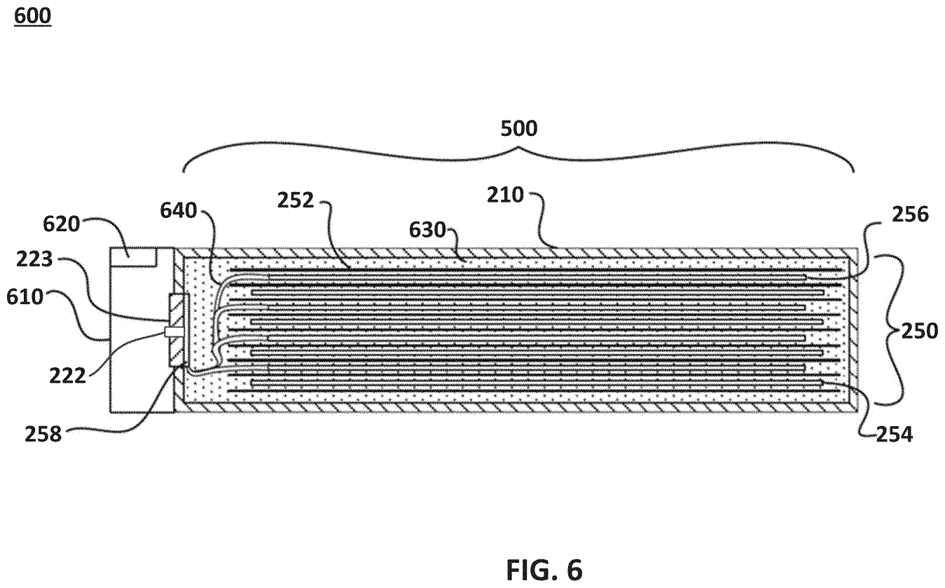

The set of layers 250 may comprise at least one cathode layer with an active coating, a separator, and at least one anode layer with an active coating, as discussed below with reference to FIG. 6.

The looped tab 258 may extend from at least one of the anode and/or cathode layers. The looped tab 258 may be joined (e.g. welded) to the connector 222 of the feedthrough 223. In one aspect, the connector 222 may be spot welded to the looped tab 258 extending from the cathode or anode of the set of layers 250. The looped tab 258 may extend from the opening 270 to facilitate a spot welding operation to the connector 222. When coupled to the looped tab 258 extending from the set of layers, electrical energy from the cathode or anode, for example, passes through the looped tab 258 and to the connector 222, to thereby provide an external terminal for the battery cell 200.

The looped tab 258 may comprise a first portion 230 and a second portion 232. The first portion 230 may be adjacent to the set of layers 250. The first portion 230 may comprise a metal surface and an insulating coating 202. The metal surface may be a conductive material, such as a material comprising aluminum oxide, nickel oxide, iron oxide, tin oxide, zinc oxide, titanium dioxide, cobalt oxide, a combination thereof, or other conductive material.

The insulating coating 202 may cover at least a portion of the metal surface of the looped tab 258. The insulating coating 202 may be a material, for example, comprising polymer.

The insulating coating 202 may be positioned to prevent contact between the set of layers 250 and the metal surface. For example, if the battery cell 200 is shaken or dropped, the set of layers 250 may move or slide towards the looped tab 258. In such a scenario, the insulating coating 202 may act as a barrier between the looped tab 258 and the set of layers 250 so that the set of layers 250 or the enclosure 210 and the metal surface of the looped tab 258 do not come into contact with each other.

The second portion 232 may be adjacent to an inner sidewall of the enclosure 210. The second portion 232 may comprise a metal surface. The metal surface may be a conductive material, such as a material comprising aluminum oxide, nickel oxide, iron oxide, tin oxide, zinc oxide, titanium dioxide, cobalt oxide, a combination thereof, or other conductive material. The second portion 232 may not be covered by the insulating coating 202. The second portion 232 may be joined to the inner sidewall of the enclosure 210.

The looped tab may be bent around a spacer 204 so that the spacer 204 is positioned between the first portion and the second portion. For example, after joining the looped tab 258 to the connector 222 of the feedthrough 223, the looped tab 258 may be configured to be folded within the enclosure 210 so that the spacer 204 is positioned between the first portion 230 and the second portion 232. The spacer 204 may be a material comprising an insulating material, such as a polymer. The spacer 204 may help to prevent the looped tab from coming into contact with the enclosure 210.

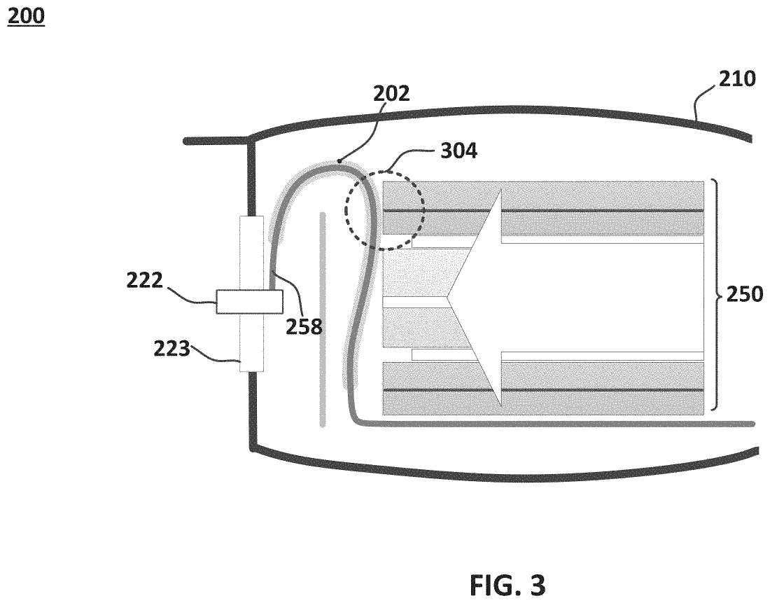

FIG. 3 illustrates a detailed cross-section view of the battery cell 200. As discussed above, the insulating coating 202 may cover a portion of the metal surface of the first portion 230 of the looped tap 258 and may be configured to prevent contact between the set of layers 250 and the metal surface. The insulating coating 202, however, may not be able to prevent contact between the set of layers 250 or the enclosure 210 and the metal surface at high temperatures.

When the battery cell 200 is exposed to high temperatures, such as temperatures near or above 150 degrees Celsius, a gas may be generated within the enclosure 210. Such build-up of gas may cause the walls of the enclosure 210 to deform and/or balloon outwards. As the walls of the enclosure deform, the set of layers 250 or the enclosure 210 and the looped tab 258 may begin to be pushed together.

The insulating coating 202 may become softer and/or melt when the battery cell is exposed to high temperatures, such as temperatures near or above 150 degrees Celsius. If the insulating coating 202 becomes softer and/or melts, the insulating coating 202 may no longer be function as a barrier between the looped tab 258 and the set of layers 250 or the enclosure 210. As the set of layers 250 and the looped tab 258 get pushed closer together, a contact 304 may occur between the conductive material of the looped tab 258 and at least one layer of the set of layers 250 or the enclosure 210. The contact 304 may cause the battery cell 200 to be shorted.

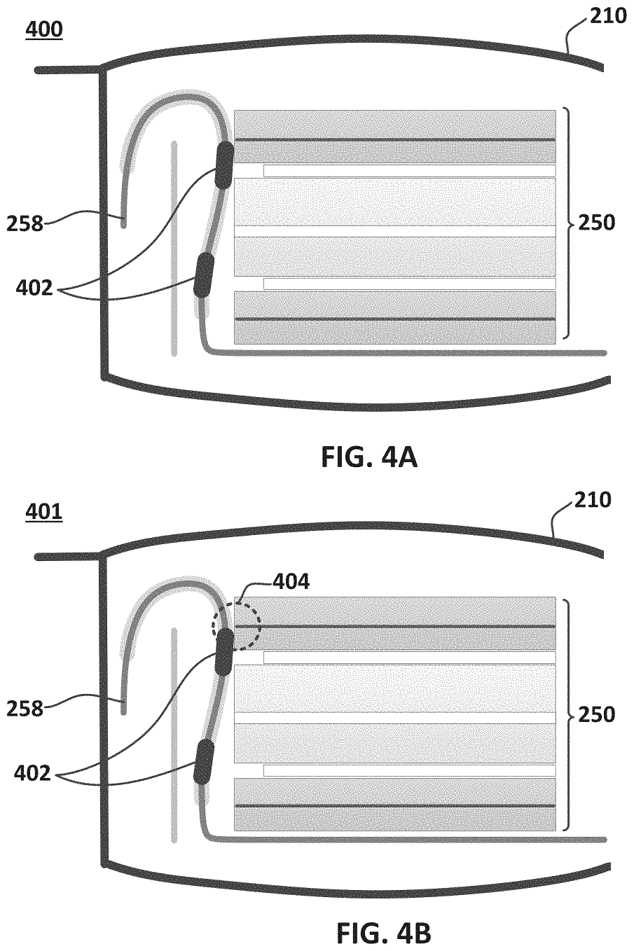

FIG. 4A illustrates a cross-section view of a battery cell 400 with the looped tab 258, in accordance with another aspect of the subject technology. The battery cell 400 comprises the enclosure 210, the set of layers 250 enclosed within the enclosure 210, and the looped tab 258, as discussed above with reference to FIG. 2.

A tape layer 402 may be applied over at least a portion of the metal surface of the first portion 230 of the looped tab 258 to provide additional contact prevention between the set of layers 250 and the metal surface at high temperatures. In an aspect, the tape layer 402 may be applied over at least a portion of the insulating coating on the metal surface of the looped tab 258. The tape layer 402 may be better able to prevent contact between the set of layers 250 or the enclosure 210 and the metal surface at high temperatures. The tape layer 402 may be able to withstand higher temperatures than the insulating coating 202 is able to, without softening and/or melting. For example, the tape layer 402 may be able to prevent contact between the set of layers 250 or the enclosure 210 and the metal surface at temperatures at or near 200 degrees Celsius.

FIG. 4B illustrates a detailed cross-section view of the battery cell 400 of FIG. 4A. While the tape layer 402 may provide additional contact prevention between the set of layers 250 or the enclosure 210 and the metal surface than the insulating layer 202, the tape layer 402 still has its disadvantages. For example, a thickness of the tape layer 402 may take up valuable space within the battery cell 400. As another example, applying the tape layer 402 to the looped tab 258 may add complexity to the manufacturing process.

As yet another example, the tape layer 402 may not be able to completely prevent contact between the set of layers 250 or the enclosure 210 and the metal surface. As discussed below with reference to FIG. 6, the set of layers in a battery cell may be immersed in an electrolyte. Immersing the set of layers 250 in an electrolyte may cause the tape layer 402 to become soaked in electrolyte. If the tape layer 402 becomes soaked in electrolyte, the tape layer 402 may become loose and/or fall off of the looped tab 258. Once it has become loose and/or fallen off of the looped tab 258, the tape layer 402 is no longer able to prevent contact between the set of layers 250 or the enclosure 210 and the metal surface.

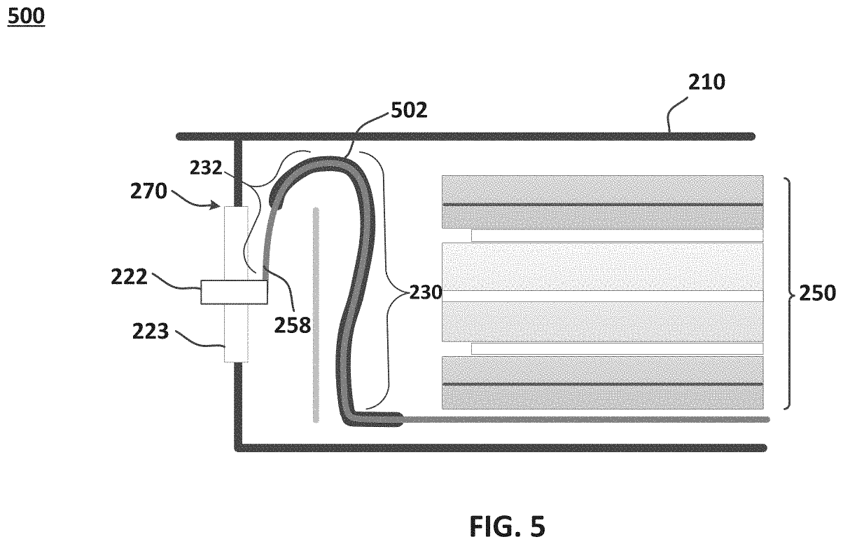

FIG. 5 illustrates a cross-section view of a battery cell 500 with the looped tab 258, in accordance with another aspect of the subject technology. The battery cell 500 comprises the enclosure 210, the set of layers 250 enclosed within the enclosure 210, and the looped tab 258, as discussed above with reference to FIG. 2.

As discussed above with reference to FIG. 4, the tape layer 402 may not be sufficient to prevent contact between the set of layers 250 and the metal surface of the looped tab 258. Instead, an oxide layer 502 may be applied over at least a portion of the metal surface of the first portion 230 of the looped tab 258. In some embodiments, the oxide layer 502 may be applied over the entire metal surface of the first portion 230 of the looped tab 258.

In an embodiment, the oxide layer 502 may be applied over at least a portion of the metal surface of the first portion 230 of the looped tab 258 and at least a portion of the metal surface of the second portion 232 of the looped tab 258. In some embodiments, the oxide layer 502 may be applied over the entire metal surface of the first portion 230 of the looped tab 258 and/or the entire metal surface of the second portion 232 of the looped tab 258. If the oxide layer 502 is applied over the entire metal surface of the first portion 230 and the entire metal surface of the second portion 232, the oxide layer 502 may cover an entire surface of the looped tab 258.

The oxide layer 502 may be better able to prevent contact between the set of layers 250 or the enclosure 210 and the metal surface at high temperatures. The oxide layer 502 may be able to withstand higher temperatures than the tape layer 402 is able to. For example, the oxide layer 502 may be able to prevent contact between the set of layers 250 or the enclosure 210 and the metal surface at temperatures at or near 500 degrees Celsius.

The oxide layer 502 may comprise any oxide material that is electrically insulating. For example, the oxide layer 502 may be a material comprising aluminum oxide, nickel oxide, iron oxide, tin oxide, zinc oxide, titanium dioxide, cobalt oxide, combinations thereof, or still other oxide layers. The oxide layer 502 may be a material comprising an oxide of a metal that is the same as or different than a metal of the metal surface beneath. For example, if the first portion of the looped tab 258 comprises a metal surface that is aluminum, the oxide layer 502 may be an aluminum oxide layer. Alternatively, the oxide layer 502 may be an oxide of a metal other than aluminum. For example, the oxide layer 502 may be nickel oxide, iron oxide, tin oxide, zinc oxide, titanium dioxide, cobalt oxide, or a combination thereof.

The oxide layer 502 may be dense. The oxide layer 502 may have a thickness of at least 1 nanometer and less than or equal to 100 microns. In some variations, the oxide layer may have a thickness of at least 10 nm. In some variations, the oxide layer may have a thickness less than or equal to 5 nm. In some variations, the oxide layer may have a thickness less than or equal to 2 nm. In some variations, the oxide layer may have a thickness less than or equal to 100 microns. In some variations, the oxide layer may have a thickness less than or equal to 90 microns. In some variations, the oxide layer may have a thickness of at least 100 microns. In some variations, the oxide layer may have a thickness of at least 95 microns. The thickness of the oxide layer 502 may be large enough to sufficiently prevent contact between the set of layers 250 and the metal surface at high temperatures, while also being small enough to fit within the battery cell 50 without taking up a large amount of space.

FIG. 6 illustrates a cross-section view of an assembled battery 600, in accordance with various aspects of the subject technology. The assembled battery 600 includes the battery cell 500, the enclosure 210, a feedthrough 223, a battery management unit 610, and battery terminals 620. The battery management unit 610 is configured to manage recharging of the battery cell 600. The terminals 620 are configured to engage with corresponding connectors on a portable electronic device to provide power to components of the portable electronic device.

The set of layers 250 comprise a cathode with an active coating 254, a separator 252, and an anode with an active coating 256. For example, the cathode 254 may be an aluminum foil coated with a lithium compound (e.g., LiCoO₂, LiNCoMn, LiCoAl or LiMn₂O₄) and the anode 256 may be a copper foil coated with carbon or graphite. The separator 252 may include polyethylene (PE), polypropylene (PP), and/or a combination of PE and PP, such as PE/PP or PP/PE/PP. The separator 252 comprises a micro-porous membrane that also provides a “thermal shut down” mechanism. If the battery cell reaches the melting point of these materials, the pores shut down which prevents ion flow through the membrane.

The plurality of layers 250 may be wound to form a jelly roll structure or can be stacked to form a stacked-cell structure. The plurality of layers 250 are enclosed within enclosure 210 and immersed in an electrolyte 630, which for example, can be a LiPF₆-based electrolyte that can include Ethylene Carbonate (EC), Polypropylene Carbonate (PC), Ethyl Methyl Carbonate (EMC) or DiMethyl Carbonate (DMC). The electrolyte can also include additives such as Vinyl carbonate (VC) or Polyethylene Soltone (PS). The electrolyte can additionally be in the form of a solution or a gel.

The feedthrough 223 may comprise a connector 222 (e.g., a pin) electrically coupled to the set of layers 250 to form an external battery terminal.

The anode layers 256 of the plurality of layers 250 may be coupled to the enclosure 210 or may be coupled to a second feedthrough via a second tab (not shown) extending from the anode layers 256. The cathode layers 254 of the plurality of layers 250 may be coupled to the looped tab 258, which may include intermediate tabs 640 extending from each cathode layer 254. The looped tab 258 and the second tab extend from the plurality of layers 250 for electrical connection to other battery cells, the battery management unit 610, or other components as desired.

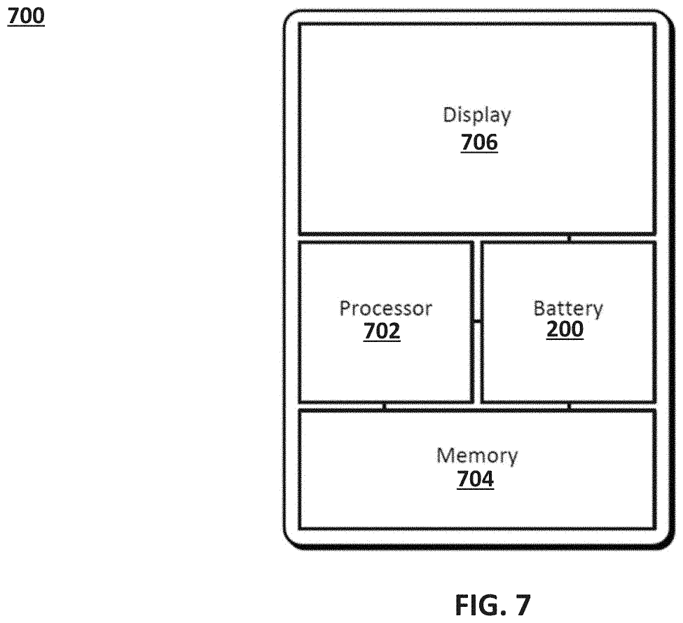

FIG. 7 illustrates a portable electronic device 700, in accordance with various aspects of the subject technology. The battery 600 can generally be used in any type of electronic device. For example, FIG. 7 illustrates a portable electronic device 700 which includes a processor 702, a memory 704 and a display 706, which are all powered by the battery 600. Portable electronic device 700 may correspond to a laptop computer, tablet computer, mobile phone, personal digital assistant (PDA), digital music player, watch, and wearable device, and/or other type of battery-powered electronic device. Battery 600 may correspond to a battery pack that includes one or more battery cells. Each battery cell may include a set of layers sealed in an enclosure, including a cathode with an active coating, a separator, an anode with an active coating, and may utilize a looped tab configured to prevent contact between the set of layers or the enclosure and a metal surface of at least a portion of the looped tab at high temperatures.

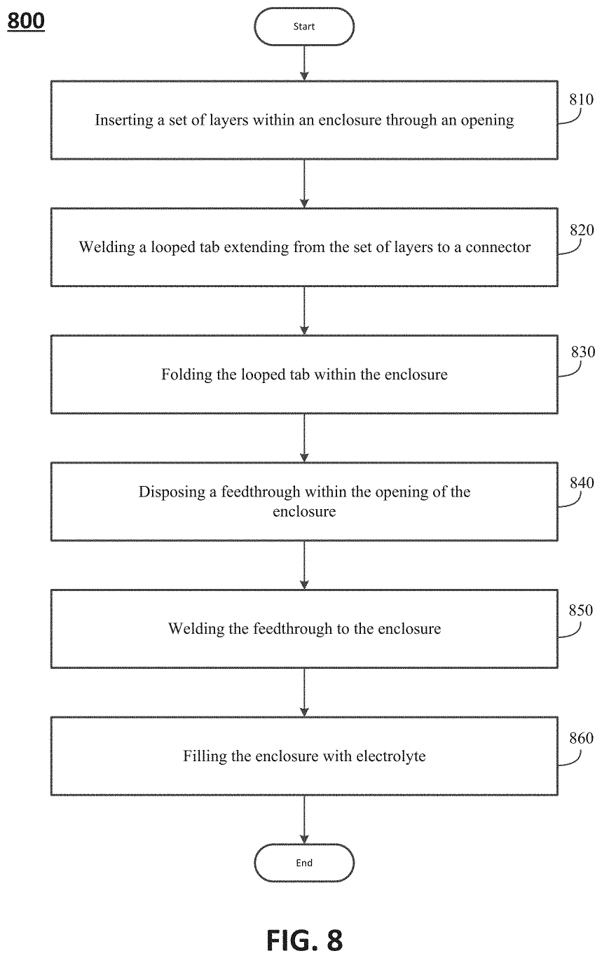

FIG. 8 illustrates an example method 800 for manufacturing a battery cell, in accordance with various aspects of the subject technology. It should be understood that, for any process discussed herein, there can be additional, fewer, or alternative steps performed in similar or alternative orders, or in parallel, within the scope of the various embodiments unless otherwise stated.

At operation 810, a set of layers 250 are inserted within an enclosure 210 through an opening 270 in the enclosure 210. The set of layers 250 comprise a cathode layer 254, an anode layer 256, and a separator layer 252 disposed between the cathode layer 254 and the anode layer 256. At operation 820, a looped tab 258 extending from the set of layers 250 is joined to a connector 222 (e.g., pin) of a feedthrough 223. The connector 222 is electrically coupled to the set of layers 250 to form an external battery terminal.

As described above, the looped tab 258 comprises a first portion 230 adjacent to the set of layers 250 and a second portion 232 adjacent to an inner sidewall of the enclosure 210. The first portion 230 comprises a covered portion, the covered portion comprising a metal surface and an oxide coating 502 covering the metal surface. The oxide coating 502 is configured to prevent contact between at least one layer of the set of layers 250 or the enclosure 210 and the metal surface of the covered portion. Generating the oxide coating 502 on the metal surface of the looped tab 258 may comprise performing at least one of hard anodization, anodization, powder coating, electroplating, physical vapor deposition, electrophoretic deposition, and microarc oxidation.

At operation 830, the looped tab 258 is folded within the enclosure 210. The looped tab 258 may be bent or curved around a spacer 204 so that the spacer 204 is positioned between the first portion 230 and the second portion 232.

At operation 840, the feedthrough 223 is disposed within the opening 270 of the enclosure 210. At operation 850, the feedthrough 223 is joined to the enclosure 210 along a periphery of the opening 270. At operation 860, the enclosure 210 is filled with electrolyte.

The method 800 may further include joining the second portion 232 of the looped tab 258 to the inner sidewall of the enclosure 210 to seal the enclosure 210.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A battery cell, comprising:
a set of layers comprising a cathode layer, an anode layer, and a separator layer disposed between the cathode layer and the anode layer;
an enclosure enclosing the set of layers, the enclosure comprising an opening for receiving a feedthrough, wherein the feedthrough comprises a connector electrically coupled to the set of layers to form an external battery terminal; and
a looped tab extending from the set of layers, the looped tab connected to the connector, wherein the looped tab comprises:
a first portion adjacent to the set of layers, and
a second portion adjacent to an inner sidewall of the enclosure, wherein at least a portion of the first portion and at least a portion of the second portion comprise a covered portion, the covered portion comprising a metal surface and an oxide coating covering the metal surface, the oxide coating configured to prevent contact between a layer in the set of layers or the inner sidewall of the enclosure and the metal surface.

2. The battery cell of claim 1, wherein the looped tab is bent around a spacer so that the spacer is positioned between the first portion and the second portion.

3. The battery cell of claim 2, wherein the spacer is an insulation material.

4. The battery cell of claim 1, wherein the enclosure is a material comprising stainless steel, aluminum, an aluminum alloy, or a combination thereof.

5. The battery cell of claim 1, wherein the oxide coating is insulating when exposed to temperatures up to 500 degrees Celsius.

6. The battery cell of claim 1, wherein the oxide coating has a thickness greater than 1 nanometer and less than 100 microns.

7. The battery cell of claim 1, wherein the metal surface is a material comprising aluminum oxide, nickel oxide, iron oxide, tin oxide, zinc oxide, titanium dioxide, cobalt oxide, or a combination thereof.

8. The battery cell of claim 1, wherein the oxide coating is a material comprising aluminum oxide, nickel oxide, iron oxide, tin oxide, zinc oxide, titanium dioxide, cobalt oxide, or a combination thereof.

9. The battery cell of claim 1, wherein the oxide coating is a material comprising an oxide of a first metal and the metal surface is a material comprising a second metal, the first metal being different than the second metal.

10. A method for manufacturing a battery cell, the method comprising:
inserting a set of layers within an enclosure through an opening, the set of layers comprising a cathode layer, an anode layer, and a separator layer disposed between the cathode layer and the anode layer;
disposing a feedthrough within the opening of the enclosure, the feedthrough comprising a connector electrically coupled to the set of layers to form an external battery terminal; and
joining a looped tab extending from the set of layers with the connector, the looped tab comprising:
a first portion adjacent to the set of layers, and
a second portion adjacent to an inner sidewall of the enclosure, wherein at least a portion of the first portion and at least a portion of the second portion comprise a covered portion, the covered portion comprising a metal surface and an oxide coating covering the metal surface, the oxide coating configured to prevent contact between a layer in the set of layers or the inner sidewall of the enclosure and the metal surface.

11. The method of claim 10, wherein the second portion further comprises an uncovered portion, the method further comprising welding the uncovered portion to the inner sidewall of the enclosure.

12. The method of claim 10, further comprising filling the enclosure with electrolyte.

13. The method of claim 10, further comprising generating the oxide coating on the metal surface.

14. The method of claim 13, wherein generating the oxide coating on the metal surface or comprises performing at least one of hard anodization, anodization, powder coating, electroplating, physical vapor deposition, electrophoretic deposition, and microarc oxidation.

15. A looped battery tab configured to extend from a set of layers of a battery cell, the looped tab comprising:
a first portion adjacent to the set of layers, and
a second portion adjacent to an inner sidewall of the enclosure, wherein at least a portion of the first portion and at least a portion of the second portion comprise a covered portion, the covered portion comprising a metal surface and an oxide coating covering the metal surface, the oxide coating configured to prevent contact between a layer in the set of layers or the inner sidewall of the enclosure and the metal surface.

16. The looped battery tab of claim 15, wherein the oxide coating is insulating when exposed to temperatures up to 500 degrees Celsius.

17. The looped battery tab of claim 15, wherein the oxide coating has a thickness greater than 1 nanometer and less than 100 microns.

18. The looped battery tab of claim 15, wherein the metal surface is a material comprising aluminum oxide, nickel oxide, iron oxide, tin oxide, zinc oxide, titanium dioxide, cobalt oxide, or a combination thereof.

19. The looped battery tab of claim 15, wherein the oxide coating is a material comprising aluminum oxide, nickel oxide, iron oxide, tin oxide, zinc oxide, titanium dioxide, cobalt oxide, or a combination thereof.

20. The looped battery tab of claim 15, wherein the oxide coating is a material comprising an oxide of a first metal and the metal surface is a material comprising a second metal, the first metal being different than the second metal.
